(19) United States
(12) Patent Application Publication
(10) Pub. No.: US 2013/0117464 A1
(43) Pub. Date: May 9, 2013

(54) PERSONALIZED MEDIA FILTERING BASED ON CONTENT

(71) Applicants: Shawn M. Brown, Sammamish, WA (US); Jason Deakins, Kirkland, WA (US); Robert Pengelly, Seattle, WA (US)

(72) Inventors: Shawn M. Brown, Sammamish, WA (US); Jason Deakins, Kirkland, WA (US); Robert Pengelly, Seattle, WA (US)

(73) Assignee: Microsoft Corporation, Redmond, WA (US)

(21) Appl. No.: 13/288,502

(22) Filed: Nov. 3, 2011

(51) Int. Cl. G06F 15/16

(52) U.S. Cl. 709/232; 709/246

(57) ABSTRACT

Personalized media filtering for a mobile electronic device can be implemented. By supporting receipt of personal media filter criteria, flexible personalization options can be implemented. Personalized media filtering can allow for interactively receiving personal media filter criteria and applying the filter criteria to the media content during the media presentation. One possible blocking response is to block portions of the content. Other possible responses include switching between broadcast stations or playlists. A prevalence metric can indicate how often a particular content item, such as a word, has been filtered from the media content. When the prevalence metric exceeds a threshold, the technology can automatically respond in a variety of ways, such as by blocking a source of the presented media content from future presentation. Interactively establishing personalized filter criteria can be implemented during ongoing presentation, for immediate use in filtering during the presentation.

### FIELD

The field pertains to personalized media content filtering via an electronic device.

### BACKGROUND

A variety of techniques have been employed throughout history to implement censorship. Some recorded entertainment media (e.g., movies) traditionally have been subjected to a censorship rating system where the content is previewed by a panel of human experts and evaluated to determine an appropriate rating (e.g., “G” for General Audiences). As an alternative to such a rating scheme, movies or audio recordings often alert viewers to objectionable content via a universal warning message (e.g., “This film/recording may contain material/lyrics intended for mature audiences”).

Censorship of live television broadcasts can be accomplished manually using a time delay during which a technician at a television station evaluates the content. The technician censors audio content by activating a bleep sound that blocks out undesirable words or phrases.

Additional techniques suitable for censoring images can also be used at the same time audio is filtered. Such censoring techniques can include, for example, pixelating, digital blurring, or black box coverage to obscure selected portions of an image that are deemed to be unsuitable for a general audience.

Such methods of censorship are executed at the source of the content transmission (i.e., by a broadcaster). Censorship criteria are typically chosen according to standards set by law or an industry organization.

While such techniques can be useful, there remains room for improvements and enhancements to censorship technology and media filtering in general.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Personalized media filtering can be implemented as described herein. For example, content can be filtered according to personal media content criteria. A method of personalized filtering of media content for a mobile electronic device having media presentation capability allows for interactively receiving personal media filter criteria during a media presentation, and applying the personal media filter criteria to the media content during presentation such that the filter criteria influence the real-time presentation of the media content.

The foregoing and other features and advantages of the invention will become more apparent from the following detailed description, which proceeds with reference to the accompanying figures.

### BRIEF DESCRIPTION OF THE DRAWINGS

FIG. 1 is a system diagram depicting an exemplary mobile device, including a variety of optional hardware and software components.

FIG. 2 is a block diagram of an exemplary system implementing personalized media filtering on a mobile device.

FIG. 3 is a flow diagram of an exemplary method of implementing personalized filtering of content media.

FIG. 4 is a flow diagram of an exemplary method of implementing a filter criteria prevalence metric for use with personalized media filtering.

FIG. 5 is a flow diagram of an exemplary method of modifying personal media filter criteria.

FIG. 6 is a mobile device screen shot of an exemplary user interface to a video player implemented on a mobile device that features personalized media filtering.

FIG. 7 is a mobile device screen shot showing an exemplary user interface that provides interactive filter criteria selection buttons for use during media presentations, according to an exemplary embodiment of a mobile device that features personalized media filtering.

FIG. 8 is a mobile device screen shot showing an exemplary user interface that displays content (e.g., song lyrics) as recognized during media presentation, by an exemplary embodiment of a mobile device that features personalized media filtering.

FIG. 9 is a mobile device screen shot showing an exemplary filter setting confirmation user interface, according to an exemplary embodiment of a mobile device that features personalized media filtering.

FIG. 10 is a flow diagram of an exemplary method for blocking content and switching to an alternate content source, in response to detecting content meeting personal media filter criteria.

FIG. 11 is a screen shot of an exemplary user interface for establishing personal media filter criteria, media content filter preferences used, or both.

FIG. 12 illustrates a generalized example of a suitable computing environment in which described embodiments, techniques, and technologies can be implemented.

### DETAILED DESCRIPTION

### Example 1

### Exemplary Mobile Device

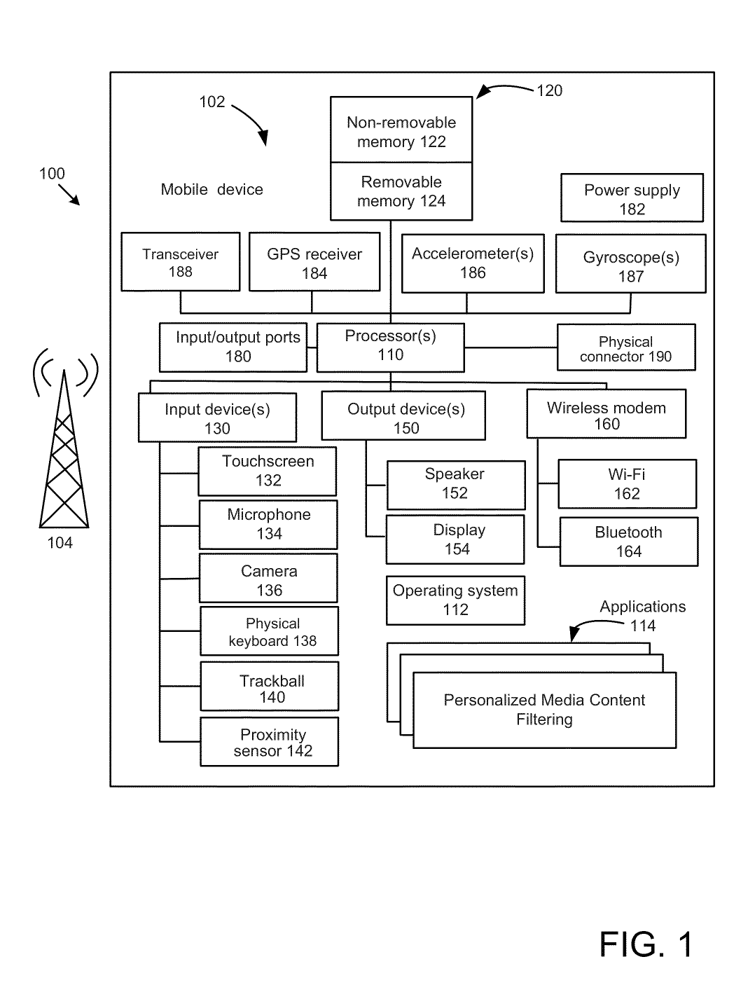

Although not so limited, any of the technologies described herein can be implemented in a mobile device. FIG. 1 is a system diagram depicting an exemplary mobile device 100 including a variety of optional hardware and software components, shown generally at 102. Any component 102 in the mobile device can communicate with any other component, although not all connections are shown, for ease of illustration. The mobile device 100 can be any of a variety of computing devices (e.g., cell phone, smartphone, tablet computer, netbook, handheld computer, Personal Digital Assistant (PDA), or other such device) and can allow wireless two-way communications with one or more mobile communications networks 104, such as a cellular or satellite network.

The illustrated mobile device 100 can include one or more controllers or processors 110 (e.g., a signal processor, microprocessor, ASIC, or other control and processing logic circuitry) for performing such tasks as signal coding, data processing, input/output processing, power control, and/or other functions. In some embodiments, the mobile device 100 includes a general processor and an image signal processor (ISP). The ISP can be coupled to the camera 136 and can include circuit components for performing operations specifically designed for image processing and/or rendering. An operating system 112 can control the allocation and usage of the components 102, including power states, and provide support for one or more application programs 114. The application programs can include common mobile computing applications (e.g., email applications, calendars, contact managers, web browsers, messaging applications), a personalized media filtering application according to the disclosed technology, or any other computing application. The application programs 114 can be stand-alone programs, or they can be partly or fully integrated into the operating system 112, or integrated with one another.

The illustrated mobile device 100 includes memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory, a Subscriber Identity Module (SIM) card, or other well-known memory storage technologies, such as “smart cards.” The memory 120 can be used for storing data and/or code for running the operating system 112 and the application programs 114. Example data can include web pages, text, images, sound files, video data, or other data sets to be sent to and/or received from one or more network servers or other devices via one or more wired or wireless networks.

The mobile device 100 can support one or more input devices 130, such as a touchscreen 132, microphone 134, camera 136, physical keyboard 138, trackball 140, and/or proximity sensor 142, and one or more output devices 150, such as a speaker 152 and one or more displays 154. Other possible output devices (not shown) can include piezoelectric or haptic output devices. Some devices can serve more than one input/output function. For example, touchscreen 132 and display 154 can be combined into a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth 164 or Wi-Fi 162). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, one or more accelerometers 186, one or more gyroscopes 187, and/or a physical connector 190, which can be a USB port, IEEE 1394 (FireWire) port, and/or RS-232 port. The accelerometer(s) 186 and/or the gyroscope(s) 187 can be implemented as micro-electro-mechanical systems (MEMS), which can be coupled to or embedded in an integrated circuit chip. The illustrated components 102 are not required or all-inclusive, as any components can be deleted and/or other components can be added.

### Example 2

### Exemplary System Implementing a Combination of the Technologies

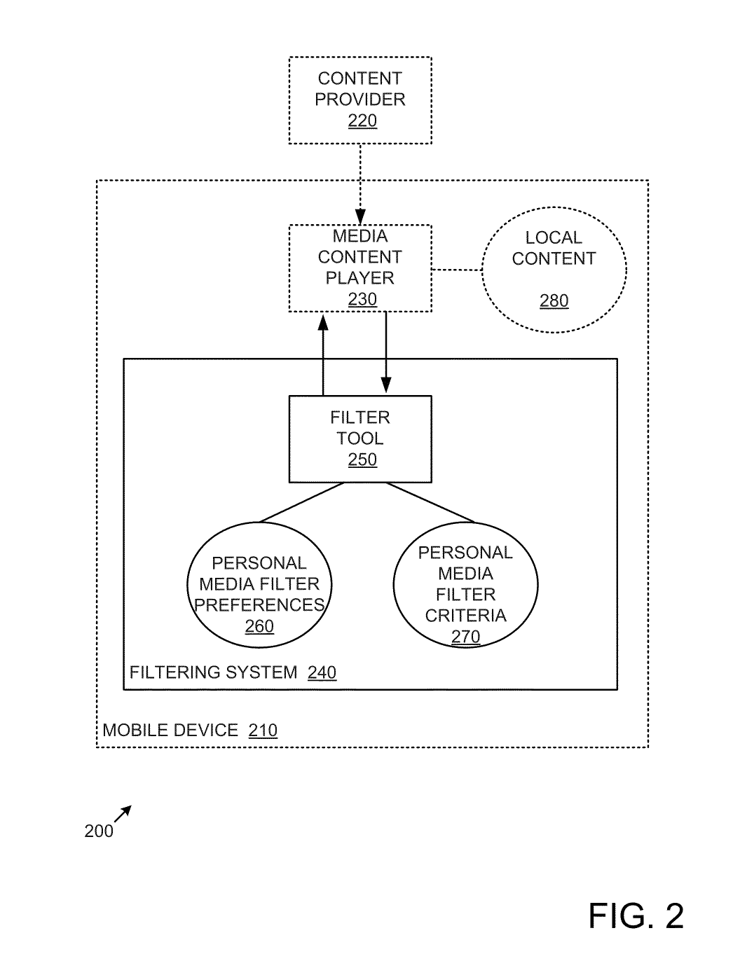

FIG. 2 is block diagram of an exemplary system 200 implementing personalized media filtering on a mobile device. The media system 200 comprises a mobile device 210 that has access to one or more content providers 220. The mobile device 210 includes a media content player 230, which can play (e.g., stream) media content from the content provider 220, local content 280 (e.g., previously downloaded), or both. Connection to the content provider 220 can be accomplished via wired connection, wireless connection, or both.

The filtering system 240 can include a filter tool 250 configured to operate according to the personal media filter preferences 260 and the personal media filter criteria 270. The filtering system 240 can be a separate application that interfaces with the media content player 230, or the filter tool 250 can be implemented as a feature of the media content player 230.

In some implementations, the media content player 230, the filtering system 240, or both can be implemented as part of the operating system for the mobile device 210.

In the example, the mobile device 210 is configured to receive media content from the content provider(s) 220. Downloadable content is typically downloaded to the device 210 for local storage as local content 280 and then presented later.

Upon receipt or selection of media content, the mobile device 210 can automatically invoke the media content player 230 to present the media content to the user, or the user can initiate running the media content player 230. The media content player 230 is capable of presenting multimedia content by simultaneously displaying a video component in a window on the mobile device screen and sending an audio component for playback through speakers or headphones. The media content player 230 is typically configured with playback buttons and features playlists that can be set up and/or customized by the user, as well as maintaining lists of favorites (e.g., favorite web pages for streaming media, favorite broadcast stations, favorite content, or the like) that can be stored either remotely (e.g., on a remote server in a computing cloud) or locally.

During presentation of the media content, the filtering system 240, which can implement the content-based personalized media filtering techniques disclosed herein, can be configured to maintain and access personal media filter preferences 260 and personal media filter criteria 270.

### Example 3

### Exemplary Media Content

In any of the examples herein, media content can include streaming content, such as streaming video from Internet-based streaming video providers (e.g., YouTube, Netflix, broadcast television, or other Internet web sites), streaming audio, or the like. Content can also be non-Internet broadcasts (e.g., over-the-air television, over-the-air radio, cable television, or the like). Content can also be of downloaded form, including video, audio (e.g., MP3) providers of recorded music, and the like.

### Example 4

### Exemplary Media Content Work

In any of the examples herein, media content works can be any separately named media content. A media content work can be a song, movie, show, episode, or the like.

As described herein, certain content within media content works can be blocked. Upon certain conditions, the entire work can be blocked (e.g., based on repeated detection of blocked content within the work). By applying the techniques herein, the source of a work (e.g., station or playlist) can also be blocked.

### Example 5

### Exemplary Personal Media Filter Preferences

The personal media filter preferences 260 can include, for example, different filtering technique options for responding to detection of content to be filtered, such as bleeping the content to be filtered, changing radio stations, shuffling to a new song, using a pixel modification technique to blur portions of a video image, and the like. Other preferences are described herein.

### Example 6

### Exemplary Personal Media Filter Criteria

The personal media filter criteria can include, for example, media content items (e.g., words, phrases, or the like), song names, movie names, performance artists, authors, or broadcast stations to be filtered from the media content presented to the user.

The filter criteria can specify criteria by indicating that if specified media content items appear in a media content work (e.g., appear in video and/or audio when the work is presented) or metadata associated with the work, the criteria are met (e.g., “hero” indicates that if “hero” appears in the audio of a work, the “hero” criterion is met).

For example, the user can specify blocking presentation of a) films directed by a particular director (or alternatively, films not directed by a particular director); b) media broadcasts from a particular radio station; c) locally stored songs by a particular artist; d) certain individual words appearing in any type of media (e.g., movies, shows, or songs); or the like.

### Example 7

### Exemplary Setting of Preferences and Criteria

A user can set the filter preferences and the filter criteria prior to media content presentation using a settings feature that allows access to a settings user interface (e.g., activated via selecting a “change settings” feature for the media player or the filtering system). Or, the filter tool 250 can be configured so that users can establish filter criteria interactively, during a media presentation, via a user interface associated with the filter tool 250 or the media content player 230. The filter criteria and preferences can be customized for different users of the mobile device, or for groups of users, based on identification information presented upon logging in to the device or through a dialog box query upon running the filter tool 250 or the media content player 230.

The preferences and criteria can be stored as a file, database, or the like as part of an operating system, a media player, or a separate filtering application. In some implementations, the preferences and criteria can be combined.

### Example 8

### Exemplary Personalized Filtering

In any of the examples herein, filtering can be personalized in that it can be specific to a user or a device. For example, media filter criteria can be received by the device when operated by a particular user.

Although personalized filtering can be supported on a device having a single user, a device having multiple users (e.g., multiple user identifiers), can keep separate preferences, criteria, or both for respective users. In this way, content might be blocked for one user but unblocked for another user of the same device.

### Example 9

### Exemplary Method Implementing a Combination of the Technologies

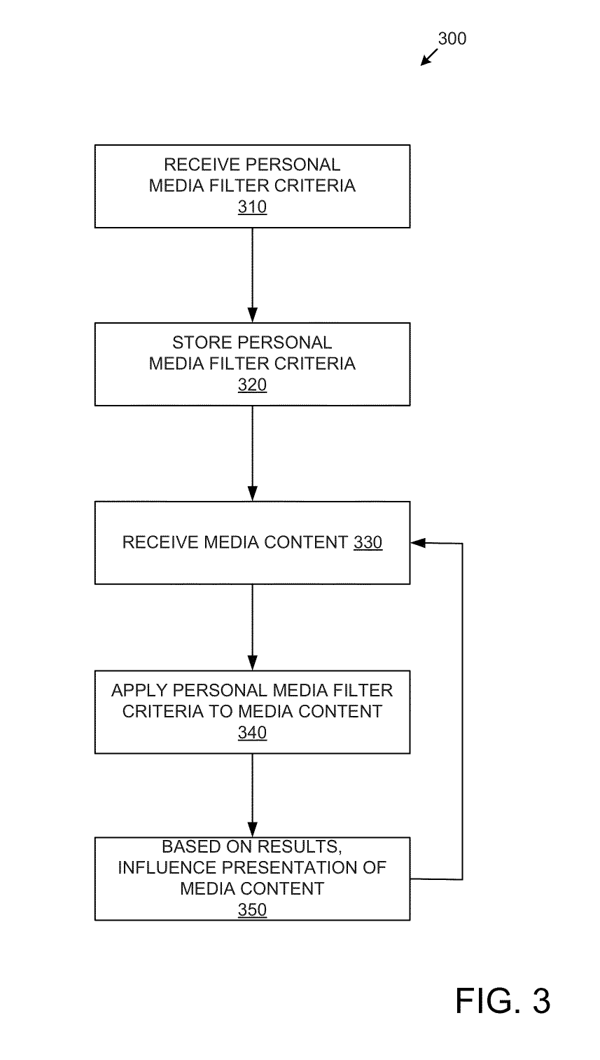

FIG. 3 is a flow diagram of an exemplary method 300 of implementing personalized filtering of media content, and can be implemented, for example, by the filtering system 240 shown in FIG. 2.

At 310, personal media filter criteria, personal media filter preferences, or both can be received (e.g., via a user interface). As described herein, personal media filter criteria can be received as part of a setting interface or interactively, while media is playing.

At 320, the personal media filter criteria, personal media filter preferences, or both are stored.

Later, at 330, media content is received for presentation (e.g., by a media content player, a filter tool, or the like).

At 340, the personal media filter criteria can be applied to filter the media content. For example, the content can be analyzed to determine whether it contains filtered content as specified by the criteria. As described herein, application of the criteria can be controlled by the personal media filter preferences.

At 350, based on the results of the filtering, presentation of the media content can be influenced as described herein.

### Example 10

### Exemplary Influencing of Presentation of Media Content

In any of the examples herein, the presentation of media content can be influenced in a variety of ways, including blocking.

Blocking can comprise obfuscation or removal of content meeting specified criteria. For example, responsive to detecting media content items in audio in the filtering process, presentation of the media content can, for example, omit such media content items (e.g., skip or fill with silence), overdub the words with a “bleep” sound, or the like. Alternatively, a speaker or other audio output can be turned off or muted.

Responsive to detecting media content items in video in the filtering process, the media content items can be blocked (e.g., pixelated, covered with a box, or otherwise obfuscated or removed). Certain media content items can be flagged to cause an entire video frame to be blocked.

As described herein, the media content items to be blocked can be indicated in personal media filter criteria.

Blocking can comprise blocking the associated media content work (e.g., the work containing media content meeting specified criteria or exceeding the prevalence metric) entirely. For example, blocking can stop presentation. Blocking can then be followed by changing broadcast channels, shuffling, or moving to the next song on the playlist, depending on what is indicated in preferences (e.g., in the personal media filter preferences 260).

Blocking can also take a prospective form by blocking future presentation of the associated media content work.

Blocking can also block a source of future content from a current broadcast station.

### Example 11

### Exemplary Real-Time Filtering

In any of the examples herein, real-time filtering can be implemented. For example, detection of media content items specified in the personal media filter criteria can be accomplished during playback or streaming of media content. Further, the blocking can then also be performed during playback. In some cases, during real-time filtering, a minor delay may be desirable to allow processing time for detection within the content being filtered.

In this way, filtering can be accomplished on the receiving end of streaming content, allowing filtering to be flexibly tailored to the criteria and preferences indicated and stored locally.

### Example 12

### Exemplary Pre-Filtering

In any of the examples herein, including real-time filtering scenarios, some of the work associated with filtering can be done in advance. For example, if media content is available locally, processing of the media content can be done (e.g., in the background, during idle times, when a device is plugged in, or the like) to identify media content items (e.g., words) in the media content. Such information can be saved as metadata associated with a media content work. Subsequently, when filtering is performed during presentation of the work, the metadata can be consulted. Alternatively, as described herein, the work may be completely blocked from presentation.

### Example 13

### Exemplary Method Implementing a Prevalence Metric

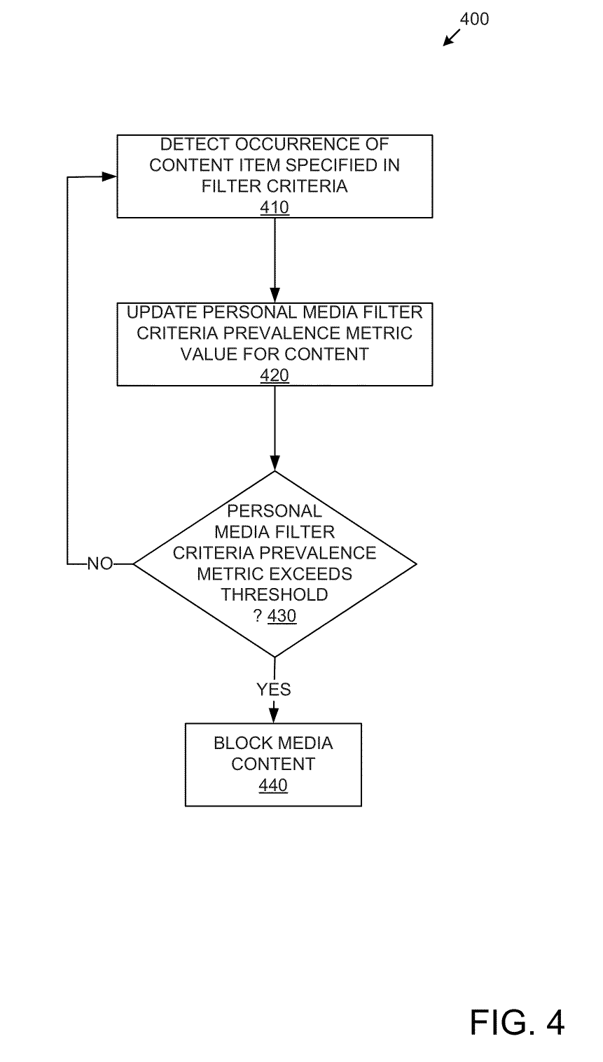

FIG. 4 is a flow diagram of an exemplary method 400 of implementing a filter criteria prevalence metric for use with personalized media filtering. The method 400 can be implemented in any of the examples herein to accomplish filtering. For example, the prevalence metric can be invoked and controlled via personal media filter preferences (e.g., preferences 260).

At 410, an occurrence of a media content item specified in media filter criteria is detected in media content (e.g., during presentation of the media content). Such detection can be accomplished during application of the media filter criteria to the content.

At 420, a personal media filter criteria prevalence metric value can be updated for the content. Occurrences of media content items specified in the media filter criteria can thus be accumulated in the metric value, which can indicate occurrences for one or more of the media content items. For example, a count of a number of times a specified media content item occurs can be increased (e.g., by a number of occurrences detected). The prevalence metric can thus measure the number of times a media content item specified in media filter criteria is detected in the media content. The filter tool 250 can calculate a sum, a percentage, or another similar quantity (e.g., number of blocked words per song) as a prevalence metric representing frequency of occurrence. In conjunction with detection, the media content item can also be blocked as described herein.

At 430, it is determined whether the prevalence metric value meets a threshold value. Such a threshold value can be specified in filter preferences described herein. For example, it can be determined whether the number of occurrences of a media content item exceeds a threshold value (e.g., controlled via preferences).

At 440, responsive to determining that the prevalence metric value meets the threshold value, presentation of the media content is blocked.

As described herein, an entire media content work can be blocked instead of simply blocking individual media content items. For example, an entire movie can be blocked instead of words from the dialogue in the soundtrack; or, all songs by a particular artist can be conditionally blocked based on an accumulated count of blocked words detected by the content filter tool 250 within the artist's repertoire.

If the prevalence metric value does not meet the threshold, accumulation of the metric continues. Instead of conditionally blocking an entire movie or a category of media, the response to the prevalence metric value exceeding the threshold can be to shuffle the presentation to a different selection, or to skip presentation of all or a portion of the content.

The type of response to be implemented in conjunction with the prevalence metric can be stored as a user preference.

### Example 14

### Exemplary Prevalence Metric

In any of the examples herein, a prevalence metric can be implemented as any measure of how prevalent media content items specified in the personalized filter criteria are in the content being filtered.

For example, for a given work, the prevalence metric can indicate how many times media content items specified in filter criteria occur, what percentage of the content (e.g., measured in time, words, or the like) meets the filter criteria, or the like.

In the case of words specified as filter criteria, the prevalence metric can indicate how many times the words appear (e.g., in the audio, video, or both) in a given work, what percentage of the words in the work are words in the filter criteria, or the like.

The threshold associated with the prevalence metric can be indicated via a user-friendly, human-readable value (e.g., “rare,” “occasional,” “pervasive,” or the like). A maturity value (e.g., “mature,” “teen,” “child,” or the like) can also be supported.

### Example 15

### Exemplary Method Implementing Receiving Filter Criteria

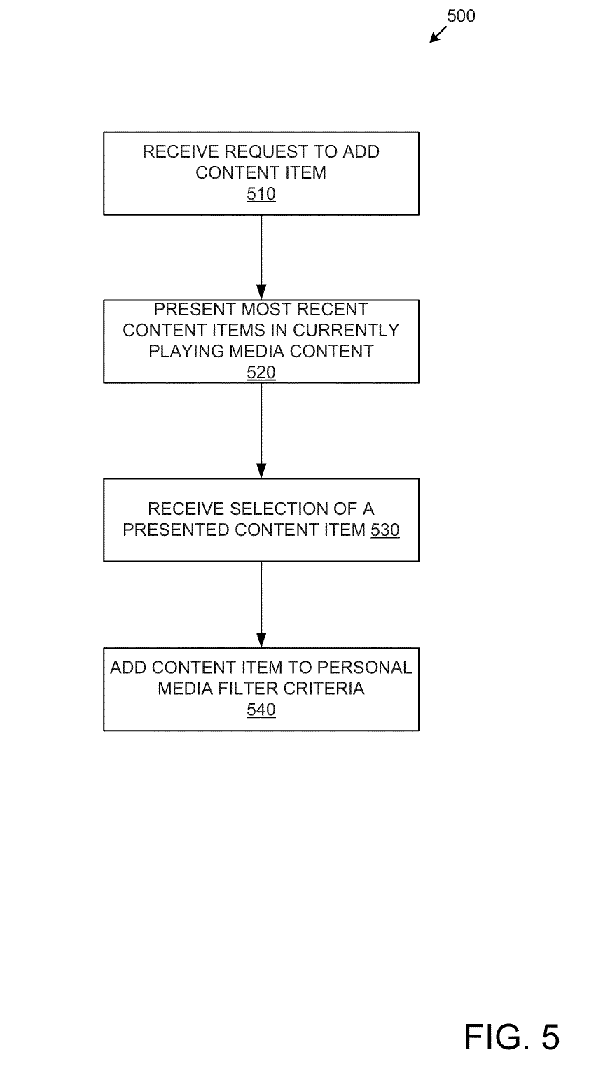

FIG. 5 is a flow diagram of an exemplary method 500 of receiving personal filter criteria. Such a technique can establish or modify personal media filter criteria and preferences in an interactive fashion, during a media presentation.

At 510, a request to add a media content item (e.g., word) to the filter criteria is received (e.g., during presentation of a media content work). Such indication can be done via a gesture, selecting a menu option, activating a graphical button, shaking, or the like.

At 520, a list of media content items recently presented (e.g., in audio of the current presentation during streaming or playback) can then be displayed (e.g., on the screen of the electronic device presenting the media content). The most recent n words can be presented. For example, recently presented song lyrics can be included in the list. The source of the list can be speech recognition functionality that analyzes spoken words and/or song lyrics during playback or streaming. Video presentations can include optical character recognition. The source of the list can be closed captioned broadcast along with the media content, or text provided with the recorded content.

Alternatively, the source of the list can be a text file (e.g., comprising song lyrics) that is stored in a header or another file that is separate from the media content itself. When the media content is transferred or uploaded (e.g., from a DVD or CD) to a soft copy format, the associated text file can be parsed along with the music, thus generating the list of media content items, 520.

At 530, a selection of one of the presented words in the list is received (e.g., by tapping the word).

At 540, the selected word can then be added to the personal media filter criteria. The criteria can be immediately applied during filtering of the ongoing presentation.

### Example 16

### Exemplary User Interface Receiving Filter Criteria

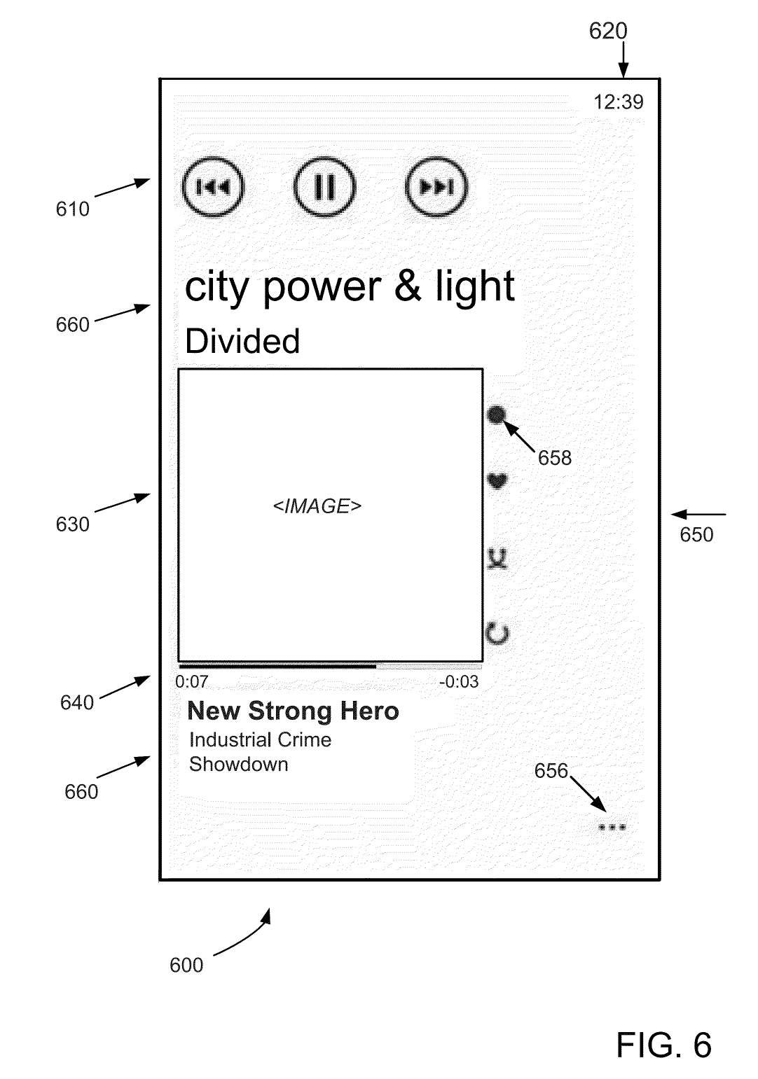

FIGS. 6-9 are exemplary screen shots presented as part of an exemplary method for interactively adding filter criteria according to the method and can be used in any of the examples described herein, including the method described in FIG. 5.

FIG. 6 shows a user interface 600 presented by an exemplary media content player (e.g., player 230 on the mobile device 210). The user interface 600 includes media player control buttons 610, a time-of-day display 620, cover art 630, a progress bar 640, a set of action buttons 650, and labels 660. The set of action buttons 650 includes a filter button 658, indicated by a solid dot icon, wherein the filter button 658 invokes interactive filtering functionality when activated. Alternatively, filter functionality can be accessed by a user interface element (e.g., element 656) for invoking a menu or some other technique.

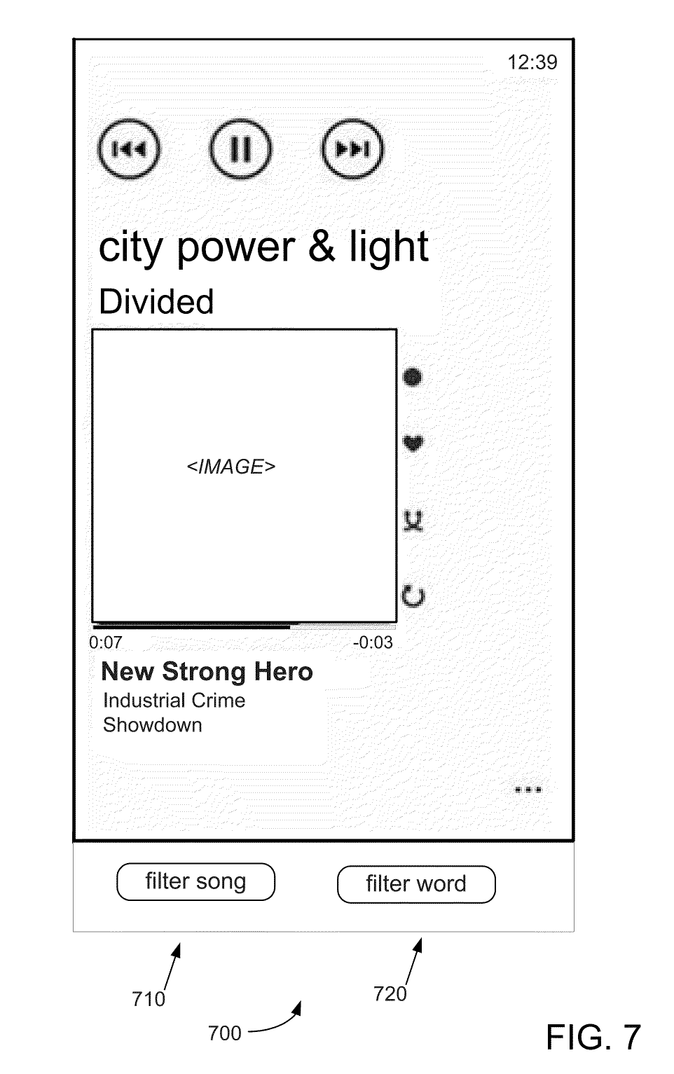

FIG. 7 shows an exemplary user interface 700 that appears when a user invokes the filtering function (e.g., by activating the filter button 658). The user interface 700 includes a button 710 for filtering a song and a button 720 for filtering a word. The user interface 700 can be invoked as a standard part of streaming, playback, or both. Or, the user interface 700 can be invoked on demand (e.g., via a menu invoker).

Responsive to activation of the “filter song” button 710, the current media content work (e.g., song) can be placed on a list to prevent playback in the future.

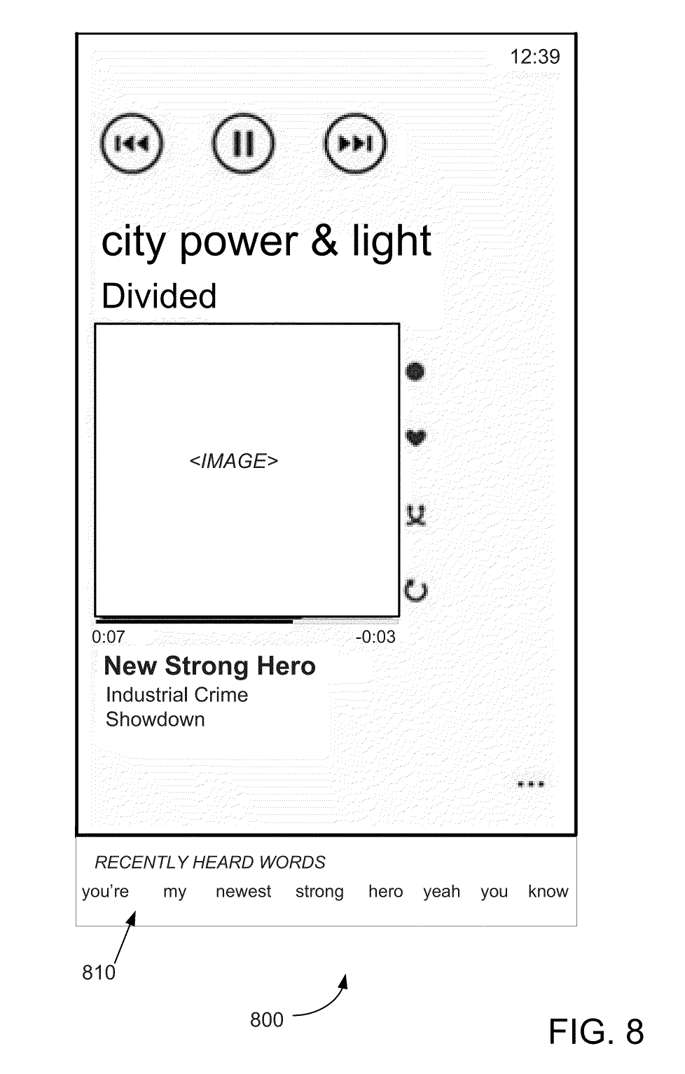

Upon selection of the “filter word” button 720, another user interface 800 of FIG. 8 can be presented. The user interface 800 presents a word list 810 of recently played (e.g., heard) words (e.g., at the bottom of the display). After the word list 810 appears, a selection of one or more of the recently played words can be received. The selected word(s) are then added to personal media filter criteria as described herein.

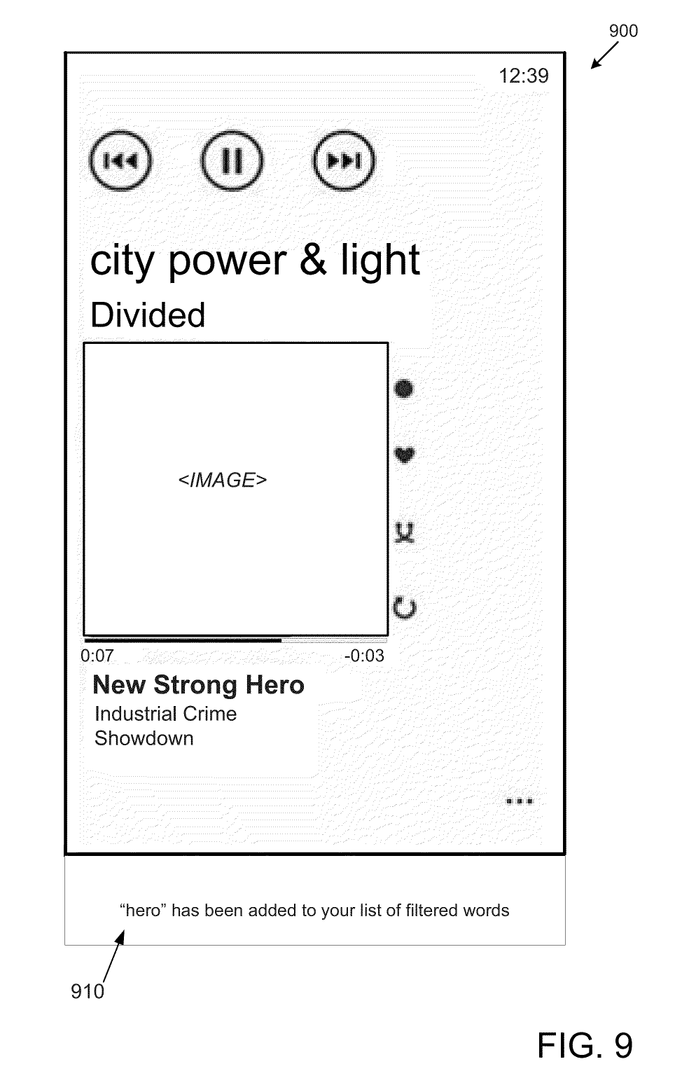

In response to the word selection, a confirmation screen 900 can be displayed in which a confirmation message 910 appears (e.g., at the bottom of the display) as shown in FIG. 9.

### Example 17

### Exemplary Method of Continuing After Blocking Playback

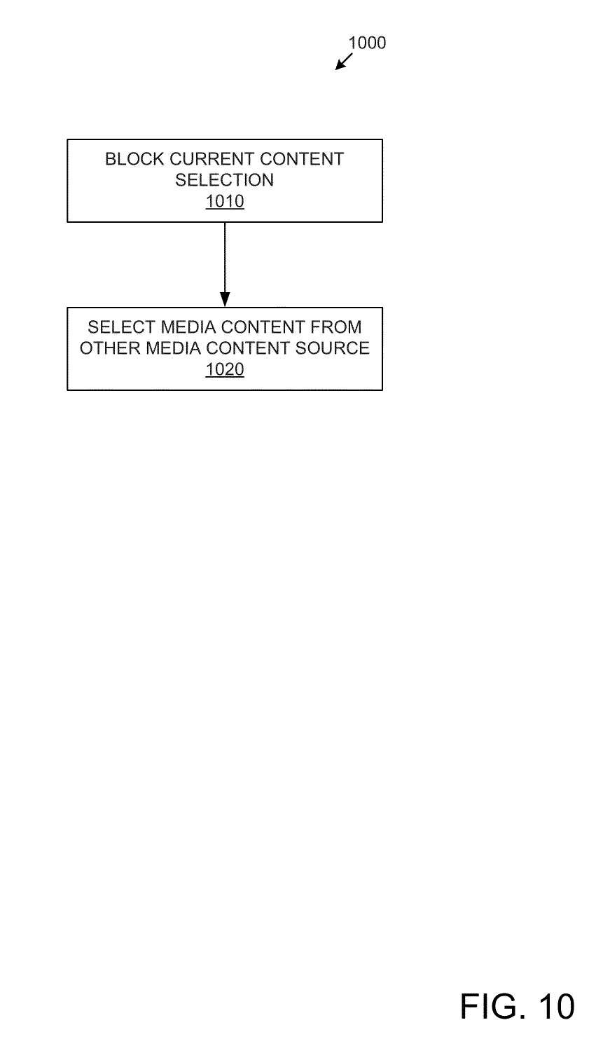

FIG. 10 is a flow diagram of an exemplary method 1000 for blocking content and switching to an alternate content source, and can be used in any of the examples described herein relating to blocking content.

The method 1000 can be used in conjunction with any of the filtering techniques described herein.

At 1010, the currently presented media content work is blocked. For example, presentation of the content work can be stopped.

At 1020, playback can continue, using a different media content source (e.g., broadcast channel or playlist).

### Example 18

### Exemplary Preferences User Interface

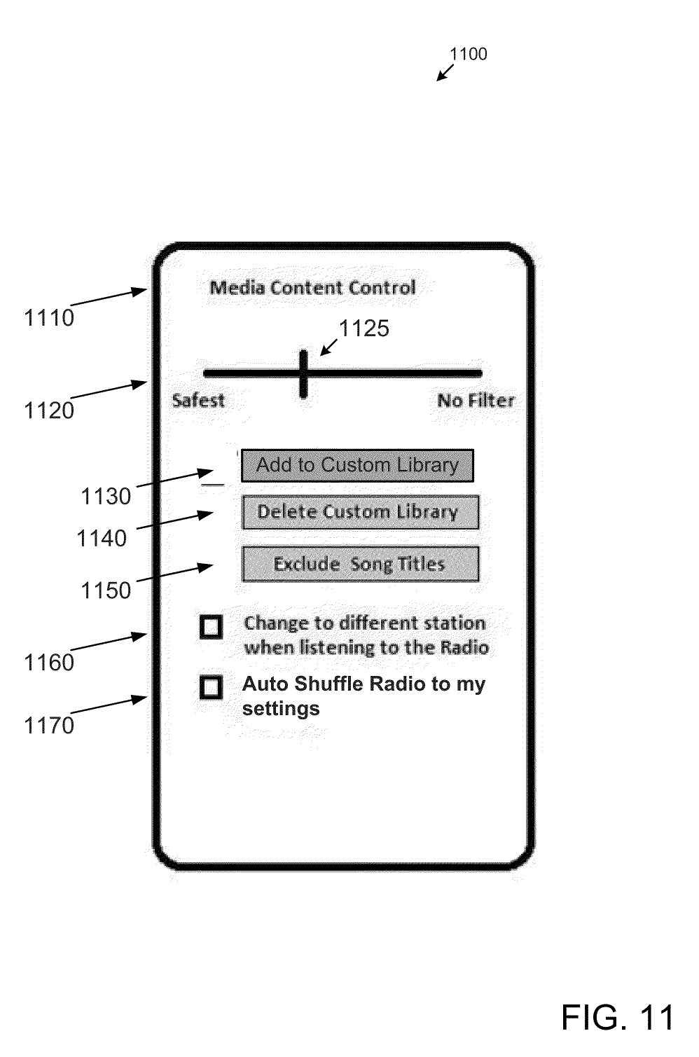

FIG. 11 is a screen shot of an exemplary user interface 1100 for establishing personal media filter criteria, personal media filter preferences, or both. Such a user interface can be used to set up personal media filter preferences (e.g., preferences 260).

The user interface 1100 can be accessed using a general “settings” feature of the mobile device (not shown) that allows a user to configure or otherwise customize various applications (e.g., applications 114 that are installed on the mobile device 210, including settings for the filter tool 250). The interface 1100 can be presented by the operating system or an individual application. Because the interface 1100 allows control over the filtering process, any of the preference user interfaces described herein can be protected from access by a password or be accessible only to an administrator.

The user interface 1100 generally allows a user to access media content control settings and indicators 1110, that can include, for example, a safety indicator 1120 having a safety slider 1125 for specifying a safety setting. The safety indicator 1120 shows the degree of filtering that is active, in the form of a continuum from “safest,” having the most stringent filtering, to “no filter.” The safety slider 1125 can be moved to select the degree of filtering desired. For example, the safety setting can be used to implement the prevalence metric described herein (e.g., “safest” indicates zero tolerance in the form of a low threshold and “no filter” indicates that the blocking is not ever to be performed).

As the slider 1125 is moved (e.g., by tapping and dragging to the right or left, along the continuum), a tool tip can appear on the display to indicate information about the currently selected setting. For example, while sliding the slider, the tool tip can show a percentage of explicit material, recommended age brackets, or a raw number of profane words spoken corresponding to the currently selected setting.

Alternatively, the safety indicator can be deployed as a displayed value (e.g., numerical value field, drop down menu, radio button, or the like) instead of as a slider 1125.

An add button 1130 can be used to specify that words are to be added to a custom library. For example, functionality for adding words (e.g., an edit field into which a word can be typed) can be invoked responsive to activation of the button 1130.

A delete button 1140 can be used to clear personal media content criteria. For example, responsive to receiving activation of the delete button 1140, the personal media content filter criteria can be erased.

An exclude button 1150 can be used to block media content works having names containing certain text. For example, responsive to activation of the exclude button 1150, an edit field is presented for accepting a string that, if the name contains the string in the title, it is prevented from playing. Wildcards can be supported.

Alternatively, the exclude button 1150 can be used to exclude one or more media content works from the filtering process. For example, responsive to receiving activation of the exclude button 1150, a name of the current work or entered work(s) can be added to a list of media content works for which filtering is not done (e.g., content is not blocked for media content works appearing in the excluded list).

A change check box 1160 can be used to force a change to a different station after blocking. For example, when box 1160 is activated, responsive to blocking content or a work, presentation can be changed to a different radio station. Thus, a response to detecting media content items appearing in the filter criteria can be to change to a different station, rather than to continue blocking individual words, phrases, or image portions from the presentation.

A shuffle check box 1170 can be used during a radio presentation, to shuffle radio stations among a list of favorites specified by the user in the settings for the personalized media filtering application. For example, when box 1170 is activated, responsive to blocking content or a work, shuffle functionality can be invoked during presentation.

### Example 19

### Additional Techniques

An option for influencing the presentation of the media content is simply to block portions of the media content (e.g., individual media content items) currently being presented. Another option is to switch between radio stations or playlists. Yet another option is to block from future presentation. Yet another option is to block a source of the media content.

Any of the techniques herein can be implemented in conjunction with the described prevalence metric. For example, when the prevalence metric exceeds a certain threshold, the mobile device can automatically respond by blocking.

Interactively establishing personalized filter criteria on the mobile device can be implemented during a media presentation, by accepting a request to add a filter criterion (such as a particular word, for example), displaying a list of words currently being presented on the mobile device, allowing a user to choose a word from the list, and adding the chosen word to the personal media filter criteria for immediate use in filtering the ongoing presentation.

### Example 20

### Exemplary Radio Stations

In any of the examples herein, a device may support conventional broadcast radio stations (e.g., AM, FM, or the like), streaming radio stations (e.g., streaming audio over the Internet of another network), or both. Any such stations can be supported by the technologies described herein.

### Example 21

### Other Implementations

Personalized filtering of media content is not limited to, nor is it necessarily focused on, censoring offensive language or images. Because of the way in which media content is managed on current playback devices, filtering can be used to search for media items related to a certain topic, to generate new playlists, or to exclude unrelated content from existing playlists. Filtering might also be used to exclude presentation of content from certain sources for example, to exclude certain broadcast media channels based on political content, religious content, or for foreign language broadcasts for which the mobile device user lacks comprehension.

Filtering can be performed during the receipt process for media transmission, instead of applying filtering before sending the media transmission. For example, automatic media filtering of Internet content can occur within a personal computing device, or media filtering of broadcast television programming can occur within a cable television set-top box, wherein the filtering criteria can be created or selected on the receiving end, so that the criteria can be tailored to individual users (e.g., viewers or listeners).

### Example 22

### Exemplary Computing Environment

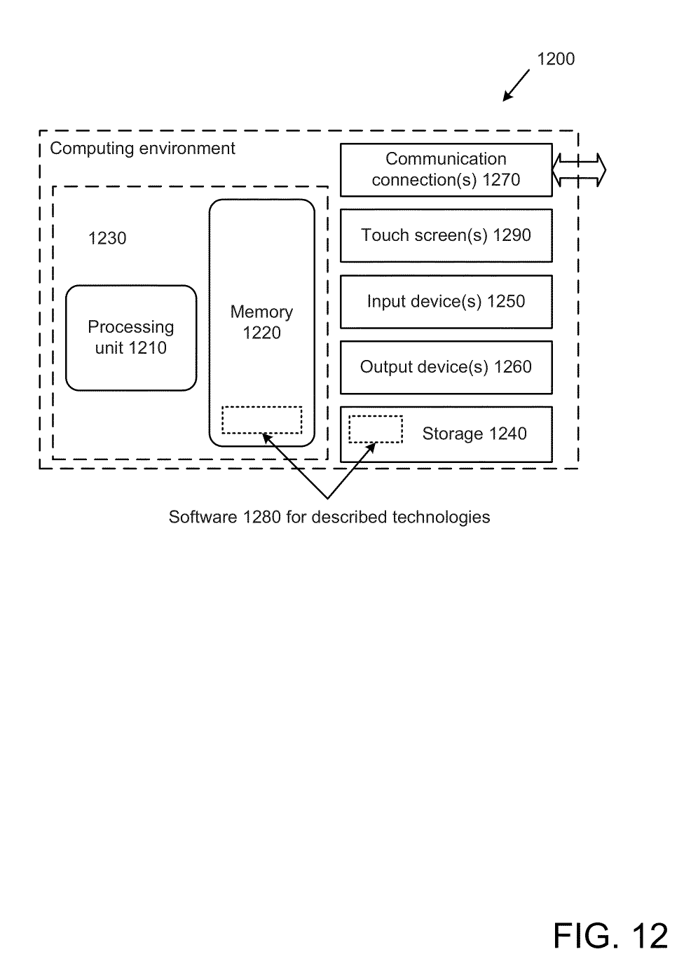

FIG. 12 illustrates a generalized example of a suitable computing environment 1200 in which embodiments of the disclosed technology can be implemented. With reference to FIG. 12, the computing environment 1200 includes at least one central processing unit 1210 and memory 1220. In FIG. 12, this basic configuration 1230 is included within a dashed line. The central processing unit 1210 executes computer-executable instructions and can be a real or a virtual processor (e.g., ultimately executing on processor hardware). In a multi-processing system, multiple processing units execute computer-executable instructions to increase processing power and as such, multiple processors can be running simultaneously. The memory 1220 can be volatile memory (e.g., registers, cache, RAM), non-volatile memory (e.g., ROM, EEPROM, flash memory, etc.), or some combination of the two. The memory 1220 stores software 1280 that can, for example, implement the technologies described herein. A computing environment can have additional features. For example, the computing environment 1200 includes storage 1240, one or more input devices 1250, one or more output devices 1260, one or more communication connections 1270, and one or more touchscreens 1290. An interconnection mechanism (not shown) such as a bus, a controller, or a network, interconnects the components of the computing environment 1200. Typically, operating system software (not shown) provides an operating environment for other software executing in the computing environment 1200, and coordinates activities of the components of the computing environment 1200.

The storage 1240 can be removable or non-removable, and includes magnetic disks, magnetic tapes or cassettes, CD-ROMs, CD-RWs, DVDs, or any other non-transitory storage medium which can be used to store information and that can be accessed within the computing environment 1200. The storage 1240 stores instructions for the software 1280, which can implement technologies described herein.

The input device(s) 1250 can be a touch input device, such as a touchscreen, keyboard, keypad, mouse, pen, or trackball, a voice input device, a scanning device, proximity sensor, image-capture device, or another device, that provides input to the computing environment 1200. For audio, the input device(s) 1250 can be a sound card or similar device that accepts audio input in analog or digital form. The output device(s) 1260 can be a display, touchscreen, printer, speaker, CD-writer, or another device that provides output from the computing environment 1200. The touchscreen 1290 can act as an input device (e.g., by receiving touchscreen input) and as an output device (e.g., by displaying an image capture application and authentication interfaces).

The communication connection(s) 1270 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 1200. By way of example, and not limitation, with the computing environment 1200, computer-readable media include memory 1220 and/or storage 1240. As should be readily understood, the term computer-readable storage media includes non-transitory storage media for data storage such as memory 1220 and storage 1240, and not transmission media such as modulated data signals.

### Example 23

### Exemplary Other Information

This disclosure is set forth in the context of representative embodiments that are not intended to be limiting in any way. As used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Additionally, the term “and/or” means any one item or combination of items in the phrase.

The described methods, systems, and apparatus described herein should not be construed as limiting in any way. Instead, this disclosure is directed toward all novel and non-obvious features and aspects of the various disclosed embodiments, alone and in various combinations and sub-combinations with one another. The disclosed methods, systems, and apparatus are not limited to any specific aspect or feature or combinations thereof, nor do the disclosed methods, systems, and apparatus require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged, omitted, or performed concurrently. Moreover, for the sake of simplicity, the attached figures may not show the various ways in which the disclosed methods, systems, and apparatus can be used in conjunction with other methods, systems, and apparatus. Additionally, the description sometimes uses terms like “produce,” “generate,” “select,” “capture,” and “provide” to describe the disclosed methods. These terms are high-level abstractions of the actual operations that are performed. The actual operations that correspond to these terms can vary depending on the particular implementation and are readily discernible by one of ordinary skill in the art.

Any of the disclosed methods can be implemented using computer-executable instructions stored on one or more computer-readable storage media (e.g., non-transitory computer-readable media, such as one or more volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application).

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, HTML5, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### Alternatives

The technologies from any example can be combined with the technologies described in any one or more other examples. In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. A method of personalized filtering of media content implemented at least in part by an electronic device, the method comprising:
receiving personal media filter criteria;
storing the personal media filter criteria;
receiving media content;
during presentation of the media content, applying the personal media filter criteria to the media content; and
based on results of the applying, influencing the presentation of the media content.

2. The method of claim 1, wherein:
influencing presentation of the media content comprises blocking presentation of a currently playing media content work.

3. The method of claim 1, wherein:
influencing presentation of the media content comprises blocking a media content item from presentation during the presentation of the media content.

4. The method of claim 3, wherein:
blocking the media content item from presentation during the presentation of the media content comprises applying at least one selected from the group consisting of:
an audio bleep technique;
a video pixellation technique; and an image blocking technique.

5. The method of claim 1, wherein:
applying the personal media filter criteria to the media content comprises detecting, in the media content, an occurrence of a word specified in the personal media filter criteria.

6. The method of claim 1, further comprising:
accumulating a prevalence metric indicating how often a particular media content item has been detected in a media content work currently being presented; and
determining whether the prevalence metric exceeds a threshold;
wherein influencing presentation of the media content comprises:
responsive to detecting that the prevalence metric meets the threshold, blocking the media content work.

7. The method of claim 6, further comprising:
responsive to detecting that the prevalence metric meets the threshold, blocking the media content work from future playback.

8. The method of claim 6, further comprising:
responsive to detecting that the prevalence metric meets the threshold, blocking one or more other media content works listed on a playlist associated with the media content work from future playback.

9. The method of claim 1, further comprising:
accepting a request to add a filter criterion during presentation of the media content;
displaying a plurality of media content items recently having been presented;
receiving a selection from the plurality of media content items; and
adding the selected media content item to the personal media filter criteria.

10. The method of claim 1, wherein the personal media filter criteria are selected from the group consisting of: words, phrases, song names, movie names, performance artists, authors, and broadcast stations.

11. The method of claim 1, wherein the media content is broadcast.

12. The method of claim 1, wherein:
the media content comprises digital streaming media; and
the media content is filtered during presentation using a time delay technique.

13. The method of claim 1, wherein:
influencing presentation of the media content comprises invoking shuffling functionality.

14. The method of claim 1 wherein:
influencing presentation of the media content comprises blocking presentation of future content from a current broadcast station.

15. An electronic device comprising:
network hardware for receiving media content;
a memory;
a display;
an audio output; and
a processor;
wherein the electronic device is programmed with a media content player and a filtering system to filter the media content during presentation on the electronic device by the media content player, wherein the filtering system comprises a filter tool that maintains and accesses personal media filter criteria and blocks media content according to the personal media filter criteria.

16. The electronic device of claim 15, wherein:
the electronic device supports a plurality of user identifiers; and
the electronic device stores a plurality of personal media filter criteria for respective of the plurality of user identifiers.

17. The electronic device of claim 15, wherein the filtering system comprises a prevalence metric threshold configurable by a user of the electronic device.

18. The electronic device of claim 15, wherein the filtering system comprises a filtering preference configurable by a user of the electronic device to specify what action is taken subsequent to blocking content.

19. The electronic device of claim 15, wherein the filtering system filters media content based on a determination of a percentage of undesirable content.

20. One or more computer-readable media storing computer-executable instructions which, when executed by a electronic device, cause the electronic device to perform a method comprising:
receiving and storing personal media filter preferences on the electronic device;
presenting a media content work comprising media content on the electronic device;
interactively receiving personal media filter criteria during presentation of the media content;
in the electronic device, applying the personal media filter criteria to the media content during presentation of the media content;
based on results of the applying, influencing real-time presentation of the media content;
accumulating a prevalence metric indicating how often a particular media content item has been detected in the media content as the media content is presented on the electronic device; and
in response to detecting that the prevalence metric meets a threshold, blocking a source associated with the media content work from future presentation on the electronic device.
